(19) United States
(12) Patent Application Publication
(10) Pub. No.: US 2010/0000675 A1
(43) Pub. Date: Jan. 7, 2010

(54) METHOD AND APPARATUS FOR MANUFACTURING MULTI-LAYER SUBSTRATE

(75) Inventors: Deok-heung Kim, Changwon-city (KR); Dong-kwan Won, Changwon-city (KR); Sang-min Lee, Changwon-city (KR); Min-woo Lee, Changwon-city (KR); Youn-kwon Jung, Changwon-city (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 12/465,871

(22) Filed: May 14, 2009

(30) Foreign Application Priority Data
Jul. 1, 2008 (KR) 10-2008-0063621

(51) Int. Cl. B29C 65/02

(52) U.S. Cl. 156/285; 156/380.9; 156/498

(57) ABSTRACT

Provided are a method and apparatus for manufacturing a multi-layer substrate. The method includes: rolling out a base substrate that is rolled up into a substrate supply roll and delivering the base substrate to a compression roller system; compressing and laminating a laminating material on the base substrate in a vacuum state using the compression roller system; and cooling the base substrate on which the laminating material is laminated.

### CROSS-REFERENCE TO RELATED PATENT APPLICATION

This application claims the benefit of Korean Patent Application No. 10-2008-0063621, filed on Jul. 1, 2008, in the Korean Intellectual Property Office, the disclosure of which is incorporated herein in its entirety by reference.

### BACKGROUND

1. Field of the Invention

The present invention relates to a multi-layer substrate, and more particularly, to a method of manufacturing a multi-layer substrate and an apparatus for manufacturing the multi-layer substrate using the method.

2. Description of the Related Art

Due to industrial development, the use of substrates has been increased in various industrial fields. In particular, as technology progresses, a demand for multi-layer substrates is increasing, in contrast to the demand for single-layer substrates.

A conventional technology for manufacturing a multi-layer substrate is as follows.

Conventionally, the following are sequentially performed: after a base substrate is provided, as the core and laminating materials are cut in a sheet-form, a lay-up process for laying-up the laminating materials on the base substrate and a lamination process for attaching the laid up laminating materials to the base substrate using heat and pressure, thereby manufacturing a multi-layer substrate. The manufactured multi-layer substrate has a form in which the laminated material covers both sides of the core such that the core is interposed between the laminated materials.

However, during the lay up process, laying-up the sheet-formed laminating materials on the base substrate should be manually performed, thereby resulting in that impurities may be easily attached to the laminating materials and the time consumed for laying-up and manufacturing is long. In addition, while multiple steps of a pressing process are required to apply pressure in the lamination process, a long time for laying-up and manufacturing is required to perform the multiple steps of the pressing process so that productivity decreases.

Thus, a new and improved manufacturing technology is needed to manufacture the multi-layer substrate.

### SUMMARY

The present invention provides a method of manufacturing a multi-layer substrate having high productivity and an apparatus for manufacturing the same using the method.

According to an aspect of the present invention, there is provided a method of manufacturing a multi-layer substrate, the method including: (a) rolling out a base substrate that is rolled up into a substrate supply roll and delivering the base substrate to a compression roller system; (b) compressing and laminating a laminating material onto the base substrate in a vacuum state using the compression roller system; and (c) cooling the base substrate on which the laminating material is laminated.

In (a), the base substrate may be delivered to the compression roller system by a roll-to-roll process.

The method may further include heating the base substrate before performing (b).

Heating the base substrate may be performed for the base substrate to have enough flexibility and facilitate lamination of the laminating material.

Heating the base substrate may be performed in a vacuum state.

The method may further include heating the laminating material before performing (b).

Heating the laminating material may be performed for the laminating material to have enough flexibility and facilitate lamination on the base substrate.

Heating the laminating material may be performed in a vacuum state.

In (b), the laminating material may be compressed to both surfaces of the base substrate.

In (c), the base substrate on which the laminating material is laminated may be compressed with a cooling roller.

The method may further include providing a predetermined tension to the base substrate that is cooled, after performing (c).

All processes may be performed in a vacuum state.

According to another aspect of the present invention, there is provided an apparatus for manufacturing a multi-layer substrate, the apparatus including: a substrate supply roll supplying a base substrate; at least one laminating material supply roll supplying a laminating material; a compression roller system receiving the base substrate from the substrate supply roll and compressing the laminating material onto the base substrate, thereby laminating the laminating material; and a cooler cooling the base substrate on which the laminating material is laminated.

The apparatus may further include a laminating material heater for heating the laminating material before the laminating material is supplied to the compression roller system.

The laminating material heater may include an infrared ray heater. The apparatus may further include a substrate preheater for heating the base substrate before the base substrate is supplied to the compression roller system.

The substrate preheater may include an infrared ray heater.

The apparatus may further include at least one vacuum chamber.

The compression roller system may be arranged in the vacuum chamber.

The substrate supply roll and the laminating material supply roll may be arranged in the vacuum chamber.

The cooler may be arranged in the vacuum chamber.

The cooler may include at least one cooling roller.

The apparatus may further include a tension controller giving a predetermined tension to the base substrate on which the laminating material is laminated.

The base substrate may be delivered by a roll-to-roll process.

### BRIEF DESCRIPTION OF THE DRAWINGS

The above and other features and advantages of the present invention will become more apparent by describing in detail exemplary embodiments thereof with reference to the attached drawings in which:

FIG. 1 is a pictorial schematic diagram illustrating an apparatus for manufacturing a multi-layer substrate and each manufacturing operation, according to an embodiment of the present invention;

FIG. 2 is a cross-sectional diagram schematically illustrating a base substrate, according to an embodiment of the present invention;

FIG. 3 is a cross-sectional diagram illustrating the base substrate to which a laminating material is laminated using a compression roller system, according to an embodiment of the present invention;

FIG. 4 is a cross-sectional diagram illustrating the laminated substrate, according to an embodiment of the present invention; and

FIG. 5 is a flowchart illustrating a method of manufacturing a multi-layer substrate, according to an embodiment of the present invention.

### DETAILED DESCRIPTION OF THE EMBODIMENTS

Hereinafter, the present invention will be described more fully with reference to the accompanying drawings, in which exemplary embodiments of the invention are shown.

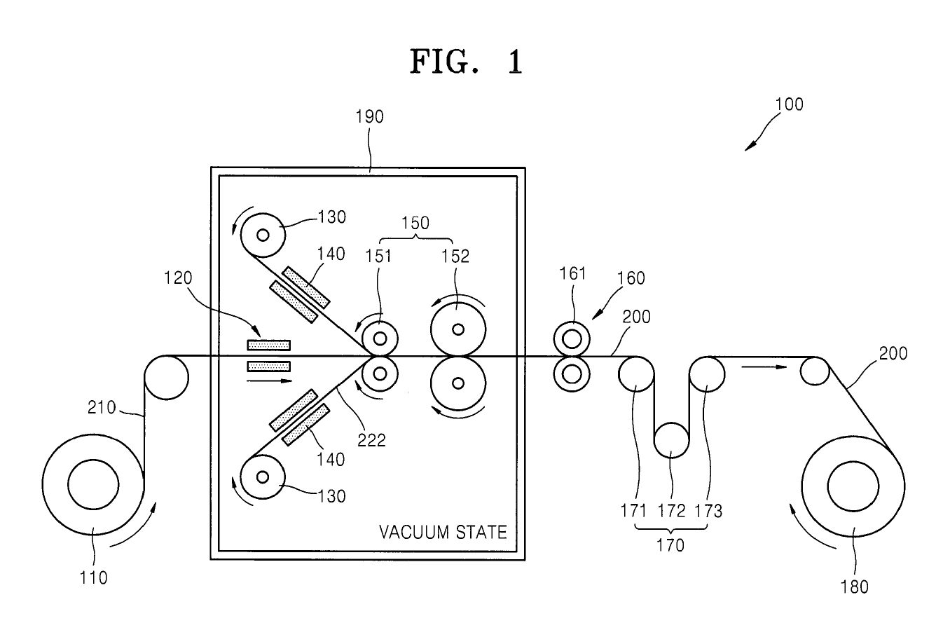

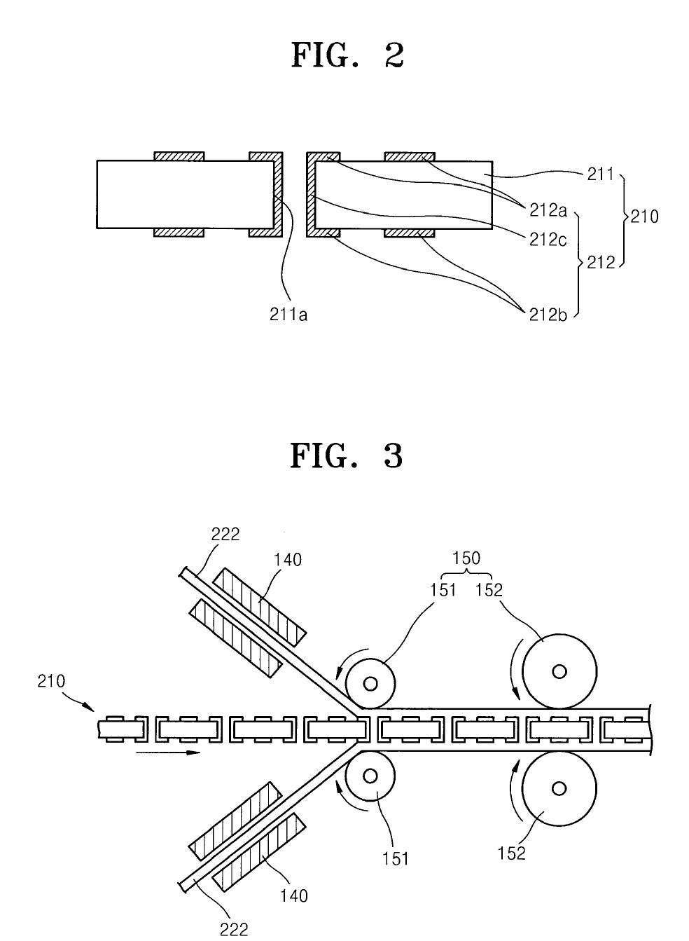

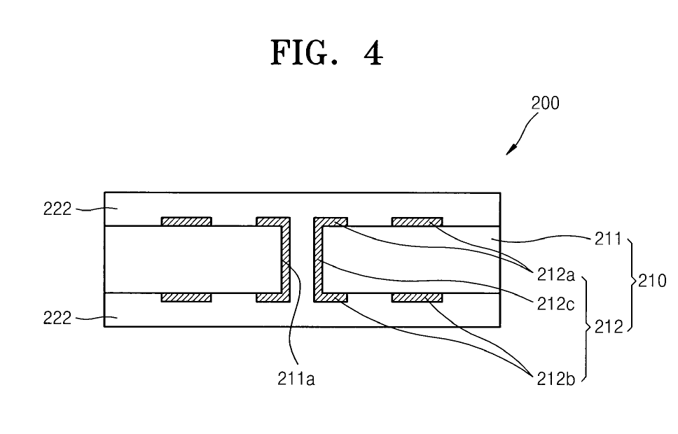

FIG. 1 illustrates an apparatus 100 for manufacturing a multi-layer substrate and each manufacturing operation, according to an embodiment of the present invention; FIG. 2 is a cross-sectional diagram schematically illustrating a base substrate 210; FIG. 3 is a cross-sectional diagram illustrating the base substrate 210 to which a laminating material 222 is laminated using a compression roller system 150; and FIG. 4 is a cross-sectional diagram illustrating the laminated substrate 200.

Referring to FIG. 1, the apparatus 100 for manufacturing a multi-layer substrate 100 includes a substrate supply roll 110, a substrate pre-heater 120, a laminating material supply roll 130, a laminating material heater 140, a compression roller system 150, a cooler 160, a tension controller 170, a substrate reclamation roll 180, and a vacuum chamber 190.

The substrate supply roll 110 is a device where the base substrate 210 is rolled up. That is, the substrate supply roll 110 has a cylinder form and the base substrate 210 on which a circuit pattern 212 is formed is rolled up into the substrate supply roll 110 by a predetermined number of times.

Referring to FIG. 2, the base substrate 210 is formed of a basic member 211 and the circuit pattern 212, wherein the basic member 211 is formed of a compound material to which a reinforcing material is added to a resin material and thus, is rigid. Here, examples of the resin material may include epoxy, phenol, polyimide, liquid crystal polymer, cyanate ester, LCP, and other polymer materials. Examples of the reinforcing material may include fiberglass and paper.

According to the current embodiment, the base substrate 210 has the characteristics of a rigid substrate; however, the present invention is not limited thereto, and thus, the base substrate 210 may be formed of resin only and thus may be flexible.

A connection hole 211a is formed on the basic member 211 by laser drilling.

The circuit pattern 212 is formed of a first circuit pattern 212a, a second circuit pattern 212b, and a connection portion 212c.

The first circuit pattern 212a includes a copper (Cu) material and is formed on a top surface of the basic member 211 using screen printing, inkjet printing, or plating.

The second circuit pattern 212b includes a copper (Cu) material and is formed on a bottom surface of the basic member 211 using screen printing, inkjet printing, or plating.

The connection portion 212c includes a copper (Cu) material and is formed on the surface of the connection hole 211a that is formed in the basic member 211, thereby electrically connecting the first circuit pattern 212a to the second circuit pattern 212b.

In the current embodiment, the first circuit pattern 212a, the second circuit pattern 212b, and the connection portion 212c are formed of a material including copper; however, the present invention is not limited thereto, and thus, the first circuit pattern 212a, the second circuit pattern 212b, and the connection portion 212c may be formed of a conductive material for forming a circuit pattern, for example, silver (Ag) and gold (Au).

The base substrate 210 rolled up into the substrate supply roll 110 is a rigid substrate. Here, the base substrate 210 is less able to be bent than a general flexible substrate. However, the base substrate 210 is flexible enough to be rolled up into the substrate supply roll 110. Thus, a diameter of the substrate supply roll 110 should be large enough for the base substrate 210 to have a curvature so that the base substrate 210 is bent and rolled up into the substrate supply roll 110.

In addition, in the present embodiment, the base substrate 210 is a double-sided substrate as illustrated in FIG. 2; however, the present invention is not limited thereto, and thus, the base substrate 210 rolled up into the substrate supply roll 110 may be a single-sided substrate having a circuit pattern formed on one surface of the base substrate 210. In addition, the base substrate 210 may be a multi-layer substrate on which multi-layer circuit patterns are formed. In this case, a lamination process is performed using the apparatus 100 for manufacturing a multi-layer substrate and thus, the multi-layer substrate—a laminated substrate 200—can be finally manufactured.

The substrate pre-heater 120 heats the base substrate 210 that is rolled out from the substrate supply roll 110 to a predetermined temperature.

When the base substrate 210 passes through the substrate pre-heater 120, the base substrate 210 is preheated and thus has an appropriate flexibility to later facilitate lamination of the laminating material 222.

The substrate pre-heater 120, according to the current embodiment, is an infrared ray heater; however, the present invention is not limited thereto and thus the substrate pre-heater 120 may be any other type of heater, as long as the base substrate 210 can be heated to the predetermined temperature.

A laminating material supply roll 130 is formed as a pair and is a device where the film-formed laminating material 222 is rolled up. That is, the laminating material supply roll 130 has a cylinder form and the laminating material 222 is rolled up into the laminating material supply roll 130 a predetermined number of times.

The laminating material 222, according to the current embodiment, is formed of an electrical-insulating polyimide resin; however, the present invention is not limited thereto, and thus, the laminating material 222 may be formed of other types or materials of an electrical-insulating resin. For example, materials for forming the laminating material 222 may include epoxy and a cyanate resin, and may be a resin coated copper (RCC) that is mostly used in a build-up substrate. Here, RCC may include a basic material formed of epoxy, a cyanate resin, and a polyimide resin in a B stage (molecular weight of 300-3000) and a copper-clad layer formed on one surface of the basic material.

The laminating material heater 140 heats the laminating material 222 that is rolled out from the laminating material supply roll 130 to a predetermined temperature and melts the laminating material 222, thereby giving an appropriate flexibility to the laminating material 222. The laminating material 222 which passes through the laminating material heater 140 is preheated and thus viscosity thereof decreases, so that lamination of the laminating material 222 onto the base substrate 210 is facilitated and a hardening reaction is generated later.

The laminating material heater 140, according to the current embodiment, is an infrared ray heater; however, the present invention is not limited thereto and thus the laminating material heater 140 may be another type of heater or use a heating method, as long as the laminating material 222 can be heated.

Meanwhile, the compression roller system 150 compresses the laminating material 222 and the base substrate 210 and is formed of a first pair of rollers 151 and a second pair of rollers 152. The base substrate 210 and the laminating material 222 pass through the compression roller system 150 and a cooler 160 and thereby having a form of a laminated substrate 200.

The first pair of rollers 151 is compression rollers and the base substrate 210 and the laminating material 222 are inserted between the first pair of rollers 151 that compresses the laminating material 222 onto the base substrate 210.

The second pair of rollers 152 is also compression rollers and additionally compresses the laminating material 222 onto the base substrate 210 so as to ensure that the laminating material 222 is compressed and to planarize the surface of the compressed laminating material 222.

The compression roller system 150, according to the current embodiment, is formed of two pairs of rollers: the first pair of rollers 151 and the second pair of rollers 152; however, the present invention is not limited thereto, and thus, the number of pairs of rollers included in the compression roller system is not particularly restricted. For example, the compression roller system 150 may be formed of one pair of rollers or third and fourth pairs of rollers may be further installed to the compression roller system 150, in addition to the first and second pairs of rollers.

The cooler 160 decreases a temperature of the laminated substrate 200 manufactured by the compression roller system 150 so that the cooler 160 prevents a rapid temperature change of the base substrate 210 and cools the laminated substrate 200 by gradually decreasing a temperature of the laminated substrate 200.

The cooler 160 is formed of a pair of cooling rollers 161, and the laminated substrate 200 passes between the pair of cooler rollers 161 while touching the cooling rollers 161 and thus a temperature of the laminated substrate 200 is gradually decreased.

The cooler 160, according to the current embodiment, is formed of the pair of cooling rollers 161; however, the present invention is not limited thereto, and thus, the cooler 160 is not particularly restricted to only the pair of cooling rollers 161, and can be other components as long as the temperature of the laminated substrate 200 can be decreased. For example, the laminated substrate 200 may be cooled with a cooler using a cold wind or a liquid at an appropriate temperature.

The tension controller 170 provides a predetermined tension to the laminated substrate 200 which passes through the cooler 160 and facilitates re-claiming of the laminated substrate 200 later by the substrate reclamation roll 180.

The tension controller 170 includes a plurality of tension rollers 171, 172, and 173 so as to apply a predetermined tension to the laminated substrate 200.

The substrate reclamation roll 180 rolls up the laminated substrate 200, which passes through the tension rollers 171, 172, and 173 of the tension controller 170, and re-claims the laminated substrate 200. Here, the substrate reclamation roll 180 is formed to have a cylinder form and a diameter large enough for the laminated substrate 200 to have a curvature so that the laminated substrate 200 is bent and rolled up into the substrate reclamation roll 180.

Meanwhile, the vacuum chamber 190 is configured to include the substrate preheater 120, the laminating material supply roll 130, the laminating material heater 140, and the compression roller system 150 and to maintain a vacuum therein. The vacuum chamber 190 facilitates the laminating material 222 to be uniformly laminated on the base substrate 210, and more particularly, to be uniformly filled into the connection hole 211a of the base substrate 210.

The vacuum chamber 190, according to the current embodiment, is configured to include the substrate preheater 120, the laminating material supply roll 130, the laminating material heater 140, and the compression roller system 150; however, the present invention is not limited thereto, and thus, the vacuum chamber 190 may be configured to include other devices or to include some of the substrate preheater 120, the laminating material supply roll 130, the laminating material heater 140, and the compression roller system 150, according to required processes, so that the selected processes may be performed in a vacuum state. For example, the vacuum chamber 190 may be configured to include only the compression roller system 150. Also, the vacuum chamber 190 may be configured to include all devices required for all of the processes.

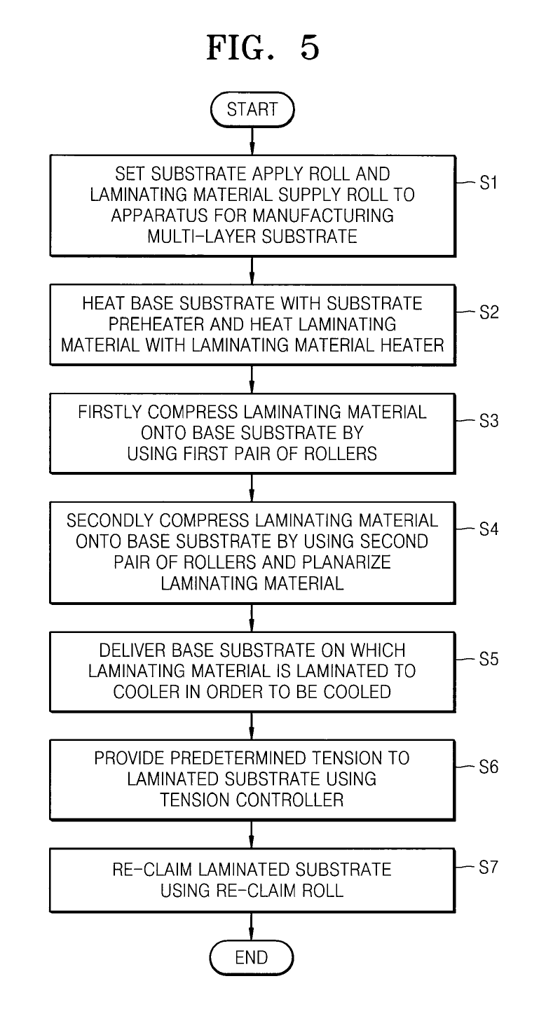

Hereinafter, a method of manufacturing the multi-layer substrate using the apparatus 100 for manufacturing a multi-layer substrate will be described with reference to FIG. 5.

FIG. 5 is a flowchart illustrating the method of manufacturing a multi-layer substrate, according to an embodiment of the present invention.

In operation S1, the substrate supply roll 110 by which the base substrate 210 is rolled up is prepared and is set to the apparatus 100 for manufacturing a multi-layer substrate, as illustrated in FIG. 1. In addition, the laminating material supply roll 130 by which the laminating material 222 is rolled up is prepared and is set to the apparatus 100 for manufacturing a multi-layer substrate, as illustrated in FIG. 1. Here, the base substrate 210 functions as the core.

Then, in operation S2, the base substrate 210 that is rolled out from the substrate supply roll 110 is delivered to the substrate pre-heater 120 located in the vacuum chamber 190 so as to be preheated. In addition, the laminating material 222 that is rolled out from the laminating material supply roll 130 is delivered to the laminating material heater 140 so as to be heated. Here, the base substrate 210 and the laminating material 222 are delivered by a roll-to-roll process.

Then, as illustrated in FIGS. 1 and 3, the heated base substrate 210 and the laminating material 222 reach the first pair of rollers 151 of the compression roller system 150 and the first pair of rollers 151 apply pressure while rotating so that the laminating material 222 is compressed onto the base substrate 210, in operation S3. In this first compressing process, a portion of the laminating material 222 flows and fills into the connection hole 211a of the base substrate 210, because the heated laminating material 222 has a low viscosity and the first pair of rollers 151 compresses laminating material 222 sufficiently.

In operation S4, the base substrate 210 and the laminating material 222 which pass through the first pair of rollers 151 reach the second pair of rollers 152 of the compression roller system 150 and the second pair of rollers 152 further compresses the laminating material 222 onto the base substrate 210, while performing a planarizing process. Through this second compressing process and planarizing process, the laminating material 222 is further compressed onto the base substrate 210 and the surface of the laminating material 222 is planarized.

Since operations S3 and S4 are performed in the vacuum chamber 190, the lamination of the laminating material 222 may be performed uniformly and precisely. In particular, a vacuum state prevents under-filling, such as bubbles, when the laminating material 222 is filled into the connection hole 211a.

In operation S5, the base substrate 210 on which the laminating material 222 is laminated is delivered to the cooler 160 to be cooled thereby. The base substrate 210 is delivered to the cooler 160 from the outside of the vacuum chamber 190 and the cooler 160 is formed of the pair of cooling rollers 161 that prevents a rapid temperature change of the base substrate 210 on which the laminating material 222 is laminated and thus prevents folds, cracks, and delamination. As such, when a cooling process using the cooler 160 is performed, the base substrate 210 on which the laminating material 222 is laminated has a form of the laminated substrate 200.

In the laminated substrate 200, the laminating material 222 is laminated on both surfaces of the base substrate 210 and in the connection hole 211a, as illustrated in FIG. 4.

In operation S6, the laminated substrate 200, which passes through the cooler 160, is provided a predetermined tension by the tension controller 170. That is, a predetermined tension is provided to the laminated substrate 200 so as to facilitate a rolling up of the laminated substrate 200 into the substrate reclamation roll 180.

In operation S7, the laminated substrate 200 to which a predetermined tension is provided is rolled up into the substrate reclamation roll 180 so that a re-claiming process of the laminated substrate 200 is completed.

In the current embodiment, the laminated substrate 200, which passes through the tension controller 170, is rolled up into the substrate reclamation roll 180; however, the present invention is not limited thereto, and thus, according to the present invention, the laminated substrate 200 which passes through the tension controller 170 may be directly delivered for the next process for manufacturing the multi-layer substrate or may be cut, instead of rolling up into the substrate reclamation roll 180, to be maintained as a sheet form.

As described above, the laminating material 222 is compressed onto and laminated on the base substrate 210 by a roll-to-roll process and thus the laminated substrate 200 is manufactured. The laminated substrate 200 manufactured as described above is connected to an external substrate by forming grooves and bumps on the laminated substrate 200 and thus is used as a double-faced substrate. However, after a conductive layer such as a copper-clad layer is patterned on both surfaces of the manufactured laminated substrate 200, the processes described above may be repeatedly performed and additional laminating material may be laminated on the manufactured laminated substrate 200, thereby manufacturing the multi-layer substrate. That is, the apparatus 100 for manufacturing a multi-layer substrate is used to easily manufacture the multi-layer substrate including multi-layers of laminated material.

As described above, according to the present embodiment, the hard laminated substrate 200 can be continuously manufactured using a roll-to-roll process and thus, the time consumed for working and manufacturing is reduced to thereby improve productivity.

In addition, according to the present embodiment, the vacuum chamber 190 is included and the laminating material 222 is laminated on the base substrate 210 in the vacuum chamber 190, and thus, the laminating material 222 can be laminated more precisely on the base substrate 210. In particular, the laminating material 222 can be uniformly filled into the connection hole 211a.

According to the present invention, a multi-layer substrate can be manufacture with high productivity.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of components configured to perform the specified functions. The particular implementations shown and described herein are illustrative examples of the invention and are not intended to otherwise limit the scope of the invention in any way. For the sake of brevity, conventional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

The use of the terms “a” and “an” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context.

The word mechanism or element is intended to be used generally and is not limited solely to mechanical embodiments. Numerous modifications and adaptations will be readily apparent to those skilled in this art without departing from the spirit and scope of the present invention.

What is claimed is:

1. A method of manufacturing a multi-layer substrate, the method comprising:
(a) rolling out a base substrate that is rolled up into a substrate supply roll and delivering the base substrate to a compression roller system;
(b) compressing and laminating a laminating material onto the base substrate in a vacuum state using the compression roller system; and
(c) cooling the base substrate on which the laminating material is laminated.

2. The method of claim 1, wherein in (a), the base substrate is delivered to the compression roller system by a roll-to-roll process.

3. The method of claim 1, further comprising heating the base substrate before performing (b).

4. The method of claim 3, wherein heating the base substrate is performed such that the base substrate has enough flexibility and facilitates lamination of the laminating material.

5. The method of claim 3, wherein heating the base substrate is performed in a vacuum state.

6. The method of claim 1, further comprising heating the laminating material before performing (b).

7. The method of claim 6, wherein heating the laminating material is performed such that the laminating material has enough flexibility and facilitates lamination on the base substrate.

8. The method of claim 6, wherein heating the laminating material is performed in a vacuum state.

9. The method of claim 1, wherein in (b), the laminating material is compressed to both surfaces of the base substrate.

10. The method of claim 1, wherein in (c), the base substrate on which the laminating material is laminated is compressed with a cooling roller.

11. The method of claim 1, further comprising providing a predetermined tension to the base substrate that is cooled, after performing (c).

12. The method of any one of claims 1 through 11, wherein all processes are performed in a vacuum state.

13. An apparatus for manufacturing a multi-layer substrate, the apparatus comprising:
a substrate supply roll supplying a base substrate;
at least one laminating material supply roll supplying a laminating material;
a compression roller system receiving the base substrate from the substrate supply roll and compressing the laminating material onto the base substrate, thereby laminating the laminating material; and
a cooler cooling the base substrate on which the laminating material is laminated.

14. The apparatus of claim 13, further comprising a laminating material heater for heating the laminating material before the laminating material is supplied to the compression roller system.

15. The apparatus of claim 14, wherein the laminating material heater comprises an infrared ray heater.

16. The apparatus of claim 13, further comprising a substrate preheater for heating the base substrate before the base substrate is supplied to the compression roller system.

17. The apparatus of claim 16, wherein the substrate preheater comprises an infrared ray heater.

18. The apparatus of claim 13, further comprising at least one vacuum chamber.

19. The apparatus of claim 18, wherein the compression roller system is arranged in the vacuum chamber.

20. The apparatus of claim 19, wherein the substrate supply roll and the laminating material supply roll are arranged in the vacuum chamber.

21. The apparatus of claim 19, wherein the cooler is arranged in the vacuum chamber.

22. The apparatus of claim 13, wherein the cooler comprises at least one cooling roller.

23. The apparatus of claim 13, further comprising a tension controller giving a predetermined tension to the base substrate on which the laminating material is laminated.

24. The apparatus of claim 13, wherein the base substrate is delivered by a roll-to-roll process.
